(19) United States
(12) Patent Application Publication
(10) Pub. No.: US 2011/0050327 A1
(43) Pub. Date: Mar. 3, 2011

(54) Semiconductor device

(75) Inventor: Kenji Fujitani, Kanagawa (JP)

(73) Assignee: NEC Electronics Corporation, Kawasaki (JP)

(21) Appl. No.: 12/801,833

(22) Filed: Jun. 28, 2010

(30) Foreign Application Priority Data
Aug. 27, 2009 (JP) 2009-196333

(51) Int. Cl. G05F 1/10

(52) U.S. Cl. 327/536

(57) ABSTRACT

Provided is a semiconductor device including: a first charge pump circuit that generates a first control signal based on electric charge of a first pumping capacitor accumulated through a first drive transistor; a second charge pump circuit that generates a second control signal based on electric charge of a second pumping capacitor accumulated through a second drive transistor; a third charge pump circuit that transfers electric charge between an output terminal and a reference voltage terminal through a third drive transistor; and a fourth charge pump circuit that transfers electric charge between the output terminal and the reference voltage terminal through a fourth drive transistor. Conductive states of the first and third drive transistors are controlled based on the second control signal, and conductive states of the second and fourth drive transistors are controlled based on the first control signal.

### INCORPORATION BY REFERENCE

This application is based upon and claims the benefit of priority from Japanese patent application No. 2009-196333, filed on Aug. 27, 2009, the disclosure of which is incorporated herein in its entirety by reference.

### BACKGROUND

1. Field of the Invention

The present invention relates to a semiconductor device, and more particularly, to a semiconductor device including a charge pump circuit.

2. Description of Related Art

Recently, in semiconductor devices, cost reduction is achieved by reducing the chip area. Meanwhile, some of the semiconductor devices include a charge pump circuit with a large circuit area as one of power supply circuits. Under this circumstance, a reduction in the area of the charge pump circuit is highly effective in reducing the cost of the semiconductor devices. However, the charge pump circuit is required to have a high current driving capability, since the charge pump circuit serves as a power supply circuit. Thus, there is a demand for a charge pump circuit having a high current driving capability and a small area.

An example of such a charge pump circuit (hereinafter, referred to as “charge pump circuit 100”) is disclosed in FIG. 5 of Japanese Unexamined Patent Application Publication No. 06-150652. The charge pump circuit 100 is a negative-voltage charge pump circuit that outputs a voltage lower than a reference voltage (e.g., ground voltage VSS). FIG. 5 shows a circuit diagram of the charge pump circuit 100. As shown in FIG. 5, the charge pump circuit 100 includes an oscillator 110, PMOS transistors 101, 102, 108, and 109, and pumping capacitors 104 and 111.

The oscillator 110 outputs complementary clock signals to thereby drive two types of charge pump circuits. One of the charge pump circuits is composed of the pumping capacitor 104 and the PMOS transistors 101 and 102 serving as rectifier elements. The other of the charge pump circuits is composed of the pumping capacitor 111 and the PMOS transistors 108 and 109 serving as rectifier elements.

Next, the operation of the charge pump circuit 100 will be described. The pumping capacitors 104 and 111 are driven in opposite phases by the complementary clock signals output from the oscillator 110. When a high-level clock signal is supplied to the pumping capacitor 104, a potential of a node 106 increases. At this time, a low-level clock signal is supplied to the pumping capacitor 111, and a potential of a node 113 decreases. Then, the PMOS transistor 101 turns on according to a potential difference between the node 106 and the node 113. As a result, the electric charge at the node 106 is discharged to the ground voltage VSS.

Subsequently, the pumping capacitor 104 receives the low-level clock signal, and the potential of the node 106 decreases. At this time, the pumping capacitor 111 receives the high-level clock signal, and the potential of the node 113 increases and the PMOS transistor 101 turns off. The potential of the node 106 decreases by the amount of electric charge discharged to the ground voltage VSS. Thus, the PMOS transistor 102 turns on according to a potential difference between a substrate and the node 106, and positive electric charge on the substrate is pumped to the node 106. Such an operation is repeated to supply a substrate current. While one of the charge pump circuits pumps the electric charge out of the substrate, the other of the charge pump circuits discharges the remaining electric charge to the ground voltage VSS. This makes it possible to supply the substrate current with low ripple.

Japanese Unexamined Patent Application Publication No. 06-150652 discloses that the current driving capability of the charge pump circuit 100 is improved by using a frequency division circuit and a multi-stage charge pump circuit (see FIG. 1 and the like of Japanese Unexamined Patent Application Publication No. 06-150652).

### SUMMARY

The present inventor has found a problem that, in any charge pump circuit disclosed in Japanese Unexamined Patent Application Publication No. 06-150652, the current driving capability of the circuit configuration is reduced. This problem will be described in detail below with reference to the charge pump circuit 100 shown in FIG. 5.

The charge pump circuit 100 pumps electric charge out of the substrate, and thus the potentials of the nodes 106 and 113 increase during a period in which the clock signal is at low level. Accordingly, a gate-source voltage VGS of each of the PMOS transistors 101 and 108 decreases during this period. Then, when the gate-source voltage VGS of each of the PMOS transistors 101 and 108 decreases, the on-resistance of the PMOS transistors 101 and 108 increases. This causes a problem that the pumping capacitors 104 and 111 supplied with the high-level clock signal are not fully charged up. Thus, if the pumping capacitors 104 and 111, which are not fully charged up, perform the subsequent charge pump operation, the amount of electric charge pumped by the pumping capacitors 104 and 111 decreases. This leads to a reduction in the current driving capability of the charge pump circuit 100.

Further, an overload state in which a large amount of electric charge is supplied to other circuits from the substrate causes a problem that the current driving capability is further reduced compared to the above-mentioned state. In the overload state, the potential of the substrate becomes lower than that in the above-mentioned state. Accordingly, the potentials of the nodes 106 and 113 during the period in which the clock signal is at low level become lower than those in the above-mentioned state. The problem in this state will be described by taking an example of the state in which a low-level clock signal is supplied to the pumping capacitor 104 and a high-level clock signal is supplied to the pumping capacitor 111 in the overload state.

In this case, the pumping capacitor 104 pumps electric charge out of the substrate, so that the potential of the node 106 increases. Meanwhile, the electric charge pumped out of the substrate during the period in which the clock signal is at low level is accumulated in the pumping capacitor 111, and the potential of the node 113 becomes lower than the ground voltage VSS. At this time, the PMOS transistor 108 turns on according to the potential of the node 106. However, the potential of the node 106 increases according to the charge pump operation by the pumping capacitor 104, and thus the on-resistance is high. For this reason, the potential of the node 113 is lower than the ground voltage VSS even when the PMOS transistor 108 turns on. On the other hand, if the potential of the node 113 is in an ideal state (e.g., ground voltage VSS), the PMOS transistor 101 completely turns off. In the overload state, however, the potential of the node 113 becomes lower than the ground voltage VSS. As a result, the PMOS transistor 101 does not completely turn off, and electric charge flows from the ground voltage VSS into the node 106 or the pumping capacitor 104. Because of the inflowing electric charge, the pumping capacitor 104 cannot fully pump electric charge out of the substrate, though the electric charge should normally be pumped out of the substrate. In short, the charge pump capability of the pumping capacitor is significantly reduced in the overload state. This causes a problem of a further reduction in the current driving capability of the charge pump circuit 100.

As described above, in the charge pump circuit 100, the potentials of the nodes 106 and 113, which increase in accordance with the charge pump operation, turn on the drive transistors (PMOS transistors 101 and 108) of the other charge pump circuit. This causes a problem of a reduction in the current driving capability. The charge pump circuits disclosed in Japanese Unexamined Patent Application Publication No. 06-150652 have a common circuit configuration. Therefore, in the technique disclosed in Japanese Unexamined Patent Application Publication No. 06-150652, the driving capability is reduced due to the circuit configuration.

As one of means for solving the problem of the reduction in the driving capability, the capacitance value of each pumping capacitor is increased. When the solving means is used, however, there is a problem of an increase in circuit area.

A first exemplary embodiment of the present invention is a semiconductor device including: an oscillator which generates complementary first and second clock signals; a first charge pump circuit which supplies, to a first pumping capacitor, electric charge according to a voltage difference between a voltage level of the first clock signal and a voltage of a reference voltage terminal, through a first drive transistor provided in a first current path, and which generates a first control signal based on the electric charge accumulated in the first pumping capacitor; a second charge pump circuit which supplies, to a second pumping capacitor, electric charge according to a voltage difference between a voltage level of the second clock signal and a voltage of the reference voltage terminal, through a second drive transistor provided in a second current path, and which generates a second control signal based on the electric charge accumulated in the second pumping capacitor; a third charge pump circuit which includes a third drive transistor that controls a conductive state of a third current path, and which transfers electric charge between the output terminal and the reference voltage terminal through the third current path; and a fourth charge pump circuit which includes a fourth drive transistor that controls a conductive state of a fourth current path, and which transfers electric charge between the output terminal and the reference voltage terminal through the fourth current path. Conductive states of the first and third drive transistors are controlled based on the second control signal. Conductive states of the second and fourth drive transistors are controlled based on the first control signal.

In the semiconductor device according to an exemplary aspect of the present invention, the current paths for collecting and discharging electric charge from the output terminal are isolated from the nodes at which the first and second control signals for controlling the drive transistors are generated. Therefore, the signal level of the first and second control signals is not affected by an increase in potential of the pumping nodes due to the electric charge pumped out of the output terminal. Consequently, in the charge pump circuit according to an exemplary aspect of the present invention, the ideal on/off state of the drive transistors can be constantly obtained, and the reduction in the current driving capability can be prevented.

The semiconductor device according to an exemplary aspect of the present invention is capable of preventing a reduction in the current driving capability without increasing the circuit area.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a circuit diagram showing a semiconductor device according to a first exemplary embodiment of the present invention;

FIG. 2 is a timing diagram showing operation of the semiconductor device according to the first exemplary embodiment;

FIG. 3 is a circuit diagram showing a semiconductor device according to a second exemplary embodiment of the present invention;

FIG. 4 is a circuit diagram showing a semiconductor device according to a third exemplary embodiment of the present invention; and

FIG. 5 is a circuit diagram showing a charge pump circuit disclosed in Japanese Unexamined Patent Application Publication No. 06-150652.

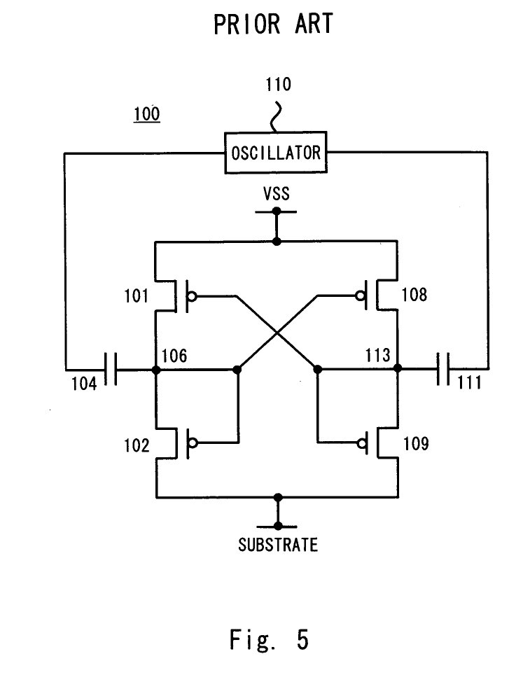

### DETAILED DESCRIPTION OF THE EXEMPLARY EMBODIMENTS

### First Exemplary Embodiment

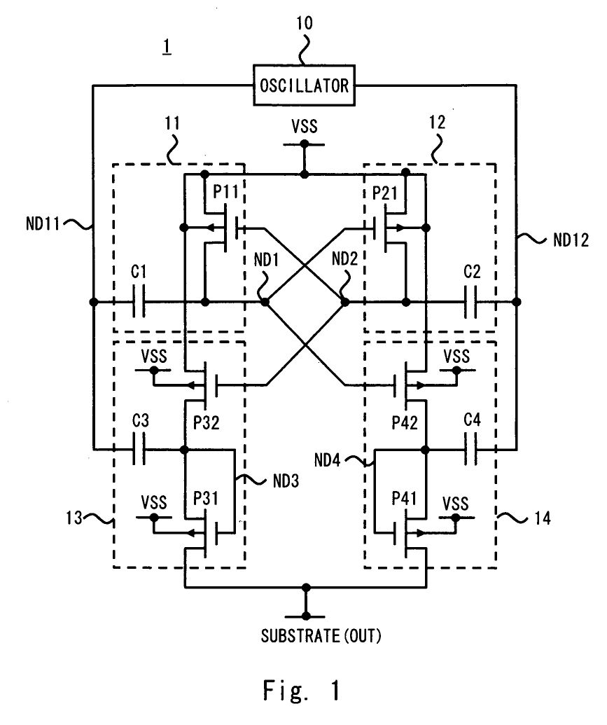

Exemplary embodiments of the present invention will be described below with reference to the accompanying drawings. FIG. 1 shows a circuit diagram of a charge pump circuit 1 provided in a semiconductor device according to a first exemplary embodiment of the present invention. As shown in FIG. 1, the charge pump circuit 1 includes an oscillator 10, a first charge pump circuit 11, a second charge pump circuit 12, a third charge pump circuit 13, and a fourth charge pump circuit 14. The charge pump circuit 1 uses a ground voltage VSS which is supplied as a reference voltage from a reference voltage terminal. Further, the charge pump circuit 1 generates a voltage for a substrate region of the semiconductor device in which the charge pump circuit is formed. That is, in the charge pump circuit 1, the substrate region of the semiconductor device corresponds to an output terminal. Assume that the charge pump circuit 1 outputs a voltage (negative voltage), which is lower than the reference voltage, to the output terminal. In the first exemplary embodiment, the ground voltage VSS is used as the reference voltage. Accordingly, the charge pump circuit according to the first exemplary embodiment includes a ground terminal as the reference voltage terminal.

The oscillator 10 outputs complementary first and second clock signals. The first clock signal output from the oscillator 10 is supplied to the first charge pump circuit 11 and the third charge pump circuit 13 through a node ND11. The second clock signal is supplied to the second charge pump circuit 12 and the fourth charge pump circuit 14 through a node ND12.

The first charge pump circuit 11 includes a first drive transistor P11 and a first pumping capacitor C1. The first pumping capacitor C1 has one terminal supplied with the first clock signal, and the other terminal connected to a first pumping node ND1 at which the first control signal is generated. In the first exemplary embodiment, a PMOS transistor is used as the first drive transistor P11. The first drive transistor P11 is connected between the first pumping node ND1 and the ground terminal. The gate of the first drive transistor P11 is connected to a second pumping node ND2. The conductive state of the first drive transistor P11 is controlled by a second control signal generated by the second charge pump circuit 12. A current path formed through the first drive transistor P11 is hereinafter referred to as a first current path. Based on this circuit configuration, the first charge pump circuit 11 supplies, to the first pumping capacitor C1, electric charge according to a voltage difference between the voltage level of the first clock signal and the ground voltage VSS, through the first drive transistor P11 provided in the first current path. Further, the first charge pump circuit 11 generates the first control signal based on the electric charge accumulated in the first pumping capacitor C1.

The second charge pump circuit 12 includes a second drive transistor P21 and a second pumping capacitor C2. The second pumping capacitor C2 has one terminal supplied with the second clock signal, and the other terminal connected to the second pumping node ND2 at which the second control signal is generated. In the first exemplary embodiment, a PMOS transistor is used as the second drive transistor P21. The second drive transistor P21 is connected between the second pumping node ND2 and the ground terminal. The gate of the second drive transistor P21 is connected to the first pumping node ND1. The conductive state of the second drive transistor P21 is controlled by the first control signal generated by the first charge pump circuit 11. A current path formed through the second drive transistor P21 is hereinafter referred to as a second current path. Based on this circuit configuration, the second charge pump circuit 12 supplies, to the second pumping capacitor C2, electric charge according to a voltage difference between the voltage level of the second clock signal and the ground voltage VSS, through the second drive transistor P21 provided in the second current path. Further, the second charge pump circuit 12 generates the second control signal based on the electric charge accumulated in the second pumping capacitor C2.

The third charge pump circuit 13 includes a first rectifier element, a third drive transistor P32, and a third pumping capacitor C3. The third pumping capacitor C3 has one terminal supplied with the first clock signal, and the other terminal connected to a third pumping node ND3. A PMOS transistor P31 is used as the first rectifier element. The PMOS transistor P31 is connected between the third pumping node ND3 and the substrate region. The gate of the PMOS transistor P31 is connected to the third pumping node ND3. In other words, the PMOS transistor P31 functions as a diode that is connected in the forward direction from the substrate region to the third pumping node ND3. In the first exemplary embodiment, a PMOS transistor is used as the third drive transistor P32. The third drive transistor P32 is connected between the third pumping node ND3 and the ground terminal. The gate of the third drive transistor 32 is connected to the second pumping node ND2. That is, the conductive state of the third drive transistor P32 is controlled by the second control signal. A current path formed through the third drive transistor P32 is hereinafter referred to as a third current path. Based on this circuit configuration, the third charge pump circuit 13 collects electric charge from the substrate region based on the first clock signal, and discharges the electric charge to the ground terminal through the third current path.

The fourth charge pump circuit 14 includes a second rectifier element, a fourth drive transistor P42, and a fourth pumping capacitor C4. The fourth pumping capacitor C4 has one terminal supplied with the second clock signal, and the other terminal connected to a fourth pumping node ND4. A PMOS transistor P41 is used as the second rectifier element. The PMOS transistor P41 is connected between the fourth pumping node ND4 and the substrate region. The gate of the PMOS transistor P41 is connected to the fourth pumping node ND4. In other words, the PMOS transistor P41 functions as a diode that is connected in the forward direction from the substrate region to the fourth pumping node ND4. In the first exemplary embodiment, a PMOS transistor is used as the fourth drive transistor P42. The fourth drive transistor P42 is connected between the fourth pumping node ND4 and the ground terminal. The gate of the fourth drive transistor P42 is connected to the fourth pumping node ND4. That is, the conductive state of the fourth drive transistor P42 is controlled by the first control signal. A current path formed through the fourth drive transistor P42 is hereinafter referred to as a fourth current path. Based on this circuit configuration, the fourth charge pump circuit 14 collects electric charge from the substrate region based on the second clock signal, and discharges the electric charge to the ground terminal through the fourth current path.

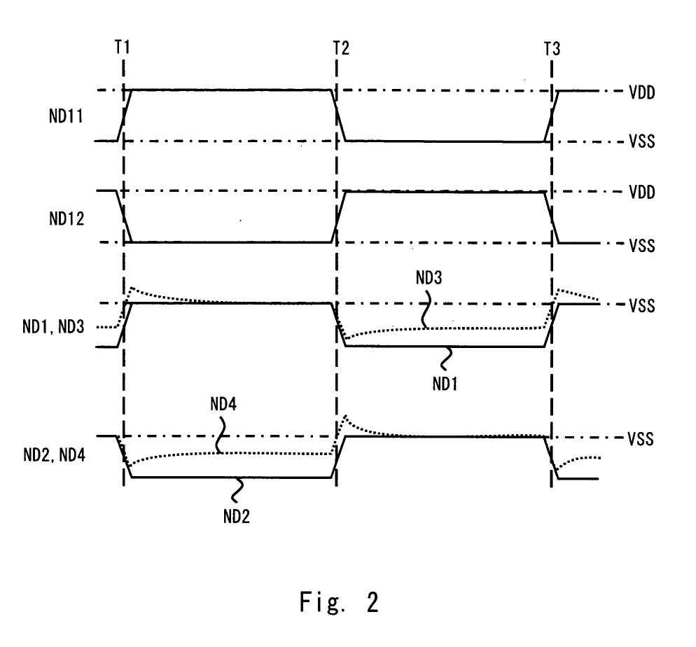

Next, the operation of the charge pump circuit 1 will be described. FIG. 2 shows a timing diagram illustrating the operation of the charge pump circuit 1. As shown in FIG. 2, the charge pump circuit 1 operates based on the first signal (signal at the node ND11 in FIG. 2) and the second clock signal (signal at the node ND12 in FIG. 2) which are generated by the oscillator 10.

First, at a timing T1, the first clock signal switches from a low level to a high level, and the second clock signal switches from the high level to the low level. In response to the switching of the clock signals, the potentials of the first pumping node ND1 and the third pumping node ND3 increase, and the potentials of the second pumping node ND2 and the fourth pumping node ND4 decrease.

In this case, when the potential of the first pumping node ND 1 increases, a gate-source voltage VGS of each of the second drive transistor P21 and the fourth drive transistor P42, which are controlled by the first control signal generated at the first pumping node ND1, becomes substantially equal to zero. Thus, the second drive transistor P21 and the fourth drive transistor P42 turn off. Then, when the fourth drive transistor P42 turns off and the potential of the fourth pumping node ND4 decreases, the second rectifier element (e.g., the PMOS transistor P41) allows a current to flow from the substrate region to the fourth pumping node ND4. This current allows the fourth charge pump circuit 14 to pump electric charge out of the substrate to the fourth pumping capacitor C4. At this time, the potential of the fourth pumping node ND4 increases. However, because the fourth pumping node ND4 is galvanically isolated from the second pumping node ND2 at which the second control signal is generated, the potential of the second control signal does not vary.

Meanwhile, when the potential of the second pumping node ND2 decreases, the drain-source voltage VGS of each of the first drive transistor P11 and the third drive transistor P32, which are controlled by the second control signal generated at the second pumping node ND2, becomes equal to or higher than a threshold. Thus, the first drive transistor P11 and the third drive transistor P32 turn on. Then, when the first drive transistor P11 turns on, the first current path is formed and the potential of the first pumping node ND1 becomes equal to the ground voltage VSS. Further, a potential difference between the ground voltage VSS and the high level of the clock signal (e.g., power supply voltage) is generated at both ends of the first pumping capacitor C1. In the first pumping capacitor C1, electric charge corresponding to the potential difference is accumulated. When the potential of the second pumping node ND2 decreases, the third drive transistor P32 turns on. As a result, the third current path is formed and the potential of the third pumping node ND3 becomes equal to the ground voltage VSS. Among the electric charges accumulated in the third pumping capacitor C3, the electric charge (excess electric charge), which is an excess of the electric charge accumulated based on the voltage difference between the ground voltage VSS and the high level voltage of the first clock signal, is discharged to the ground terminal through the third current path. At this time, the voltage across both ends of the first rectifier element (PMOS transistor P31) is a reverse voltage of the diode. Accordingly, no current flows in the direction from the third pumping capacitor C3 to the substrate region.

Next, at a timing T2, the first clock signal switches from the high level to the low level, and the second clock signal switches from the low level to the high level. In response to the switching of the clock signals, the potentials of the first pumping node ND1 and the third pumping node ND3 decrease, and the potentials of the second pumping node ND2 and the fourth pumping node ND4 increase.

In this case, when the potential of the first pumping node ND1 decreases, the gate-source voltage VGS of each of the second drive transistor P21 and the fourth drive transistor P42, which are controlled by the first control signal generated at the first pumping node ND1, becomes equal to or higher than the threshold. Thus, the second drive transistor P21 and the fourth drive transistor P42 turn on. Then, when the second drive transistor P21 turns on, the second current path is formed and the potential of the second pumping node ND2 become equal to the ground voltage VSS. A potential difference between the ground voltage VSS and the high level of the clock signal (e.g., power supply voltage) is generated at both ends of the second pumping capacitor C2. In the second pumping capacitor C2, electric charge corresponding to the potential difference is accumulated. When the potential of the first pumping node ND1 decreases, the fourth drive transistor P42 turns on. As a result, the fourth current path is formed and the potential of the fourth pumping node ND4 becomes equal to the ground voltage VSS. Among the electric charges accumulated in the fourth pumping capacitor C4, the electric charge (excess electric charge), which is an excess of the electric charge accumulated based on the voltage difference between the ground voltage VSS and the high level voltage of the first clock signal, is discharged to the ground terminal through the fourth current path. At this time, the voltage across both ends of the second rectifier element (PMOS transistor P41) is a reverse voltage of the diode. Accordingly, no current flows in the direction from the fourth pumping capacitor C4 to the substrate region.

Meanwhile, when the potential of the second pumping node ND2 increases, the gate-source voltage VGS of each of the first drive transistor P11 and the third drive transistor P32, which are controlled by the second control signal generated at the second pumping node ND2, becomes substantially equal to zero. Thus, the first drive transistor P11 and the third drive transistor P32 turn off. Then, when the third drive transistor P32 turns off and the potential of the third pumping node ND3 decreases, the first rectifier element (e.g., the PMOS transistor P31) allows a current to flow from the substrate region to the third pumping node ND3. This current allows the third charge pump circuit 13 to pump electric charge out of the substrate to the third pumping capacitor C3. At this time, the potential of the third pumping node ND3 increases. However, because the third pumping node ND3 is galvanically isolated from the first pumping node ND1 at which the first control signal is generated, the potential of the first control signal does not vary.

During a period after a timing T3, the operation at the timing T1 and the operation at the timing T2 are repeated.

As described above, the charge pump circuit 1 provided in the semiconductor device according to an exemplary embodiment of the present invention has the following configuration. That is, the current path for connecting the third pumping node ND3 and the fourth pumping node ND4, to which electric charge is pumped out of the substrate region, with the ground terminal for discharging the electric charge, is galvanically isolated from the first and second pumping nodes ND1 and ND2 at which the potentials of the first and second control signals are generated, respectively. Accordingly, in the charge pump circuit 1, the variation in potential of the third pumping node ND3 and the fourth pumping node ND4 due to the charge pump operation has no influence on the potentials of the first and second control signals. Therefore, in the charge pump circuit 1, the driving capability of the first to fourth drive transistors is not reduced. Moreover, the first to fourth current paths formed by the first to fourth drive transistors can be brought into an ideal state, independently of the potential of the substrate region. In other words, in the charge pump circuit 1, the current driving capability is not reduced due to the circuit configuration, and the current driving capability determined by the capacitance values of the third pumping capacitor C3 and the fourth pumping capacitor C4 can be fully utilized. In short, the charge pump circuit 1 provided in the semiconductor device according to an exemplary embodiment of the present invention can be formed with a minimum circuit area.

Further, in the charge pump circuit 1, the gate-source voltage VGS of the drive transistors is not decreased due to the effect of the substrate potential. For this reason, charging and discharging of the third pumping node ND3 and the fourth pumping node ND4 can be performed in a short time. Therefore, in the charge pump circuit 1 provided in the semiconductor device according to an exemplary embodiment of the present invention, a reduction in operation speed of the charge pump can be prevented.

The first and second control signals correspond to signals obtained by shifting the level of the amplitude range of the first and second clock signals. In the charge pump circuit 1 according to the first exemplary embodiment, the first and second control signals are generated by the first and second charge pump circuits 11 and 12, respectively. A level shift circuit or the like is generally used to generate a level-shifted signal. The level shift circuit, however, requires a separate power supply corresponding to the amplitude range obtained after the level shift. Meanwhile, in the charge pump circuit 1 according to this exemplary embodiment, a level-shifted signal is generated by the first charge pump circuit 11 and the second charge pump circuit 12. This eliminates the need for the separate power supply. In view of the above, the charge pump circuit 1 provided in the semiconductor device according to an exemplary embodiment of the present invention can be achieved with a simple circuit configuration, and prevents an increase in circuit area.

### SECOND EXEMPLARY EMBODIMENT

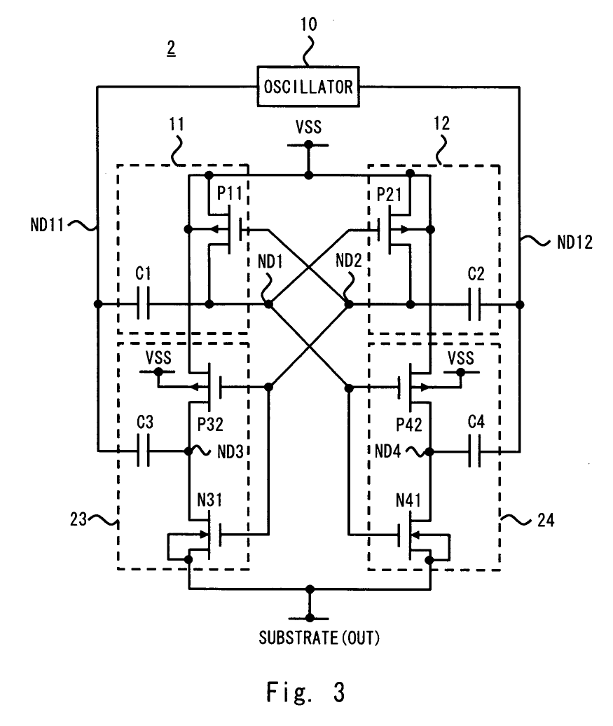

FIG. 3 shows a circuit diagram of a charge pump circuit 2 according to a second exemplary embodiment of the present invention. As shown in FIG. 3, the charge pump circuit 2 has a configuration in which the first and second rectifier elements of the charge pump circuit 1 according to the first exemplary embodiment are implemented using NMOS transistors. In the charge pump circuit 2 according to the second exemplary embodiment, an NMOS transistor N31 is used as the first rectifier element, and an NMOS transistor N41 is used as the second rectifier element.

The NMOS transistor N31 has a source (terminal connected to a backgate terminal) connected to the substrate region, a drain connected to the third pumping node ND3, and a gate connected to the second pumping node ND2. That is, the conductive state of the NMOS transistor N31 is controlled by the second control signal. The NMOS transistor N41 has a source (terminal connected to a backgate terminal) connected to the substrate region, a drain connected to the fourth pumping node ND4, and a gate connected to the first pumping node ND1. That is, the conductive state of the NMOS transistor N41 is controlled by the first control signal.

Thus, when the third drive transistor P32 and a first drive element (or the fourth drive transistor P42 and a second drive element) are composed of transistors having opposite polarities, the conductive states of the drive transistor and the rectifier element can be controlled exclusively based on the same control signal. In other words, the pump operation (specifically, operation for collecting electric charge from the substrate region and discharging electric charge to the ground terminal) of the charge pump circuit 2 is substantially the same as that of the charge pump circuit 1.

On the other hand, in the charge pump circuit 2, a diode is not used as the rectifier element. This is effective in improving the current driving capability compared to the charge pump circuit 1, for the following reason. That is, when a diode is used as the rectifier element, the amount of electric charge that can be accumulated in the third pumping capacitor C3 and the fourth pumping capacitor C4 is decreased due to a forward voltage of the diode. Meanwhile, when a transistor (especially, a MOS transistor) is used as the rectifier element, the amount of electric charge that can be accumulated in the third pumping capacitor C3 and the fourth pumping capacitor C4 can be increased compared to the case of using a diode. In short, the charge pump circuit 2 according to the second exemplary embodiment can improve the current driving capability compared to the charge pump circuit 1 according to the first exemplary embodiment.

[Third exemplary embodiment]

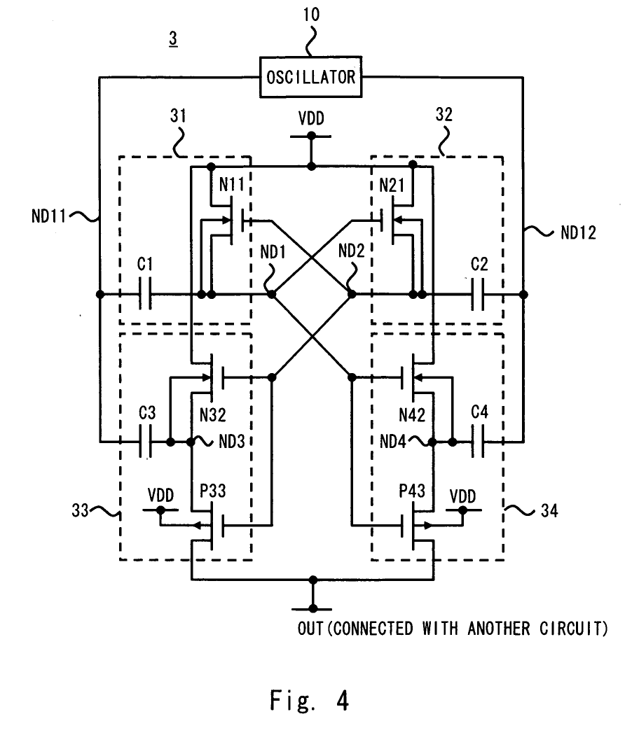

FIG. 4 shows a circuit diagram of a charge pump circuit 3 according to a third exemplary embodiment of the present invention. The charge pump circuit 3 is a positive-voltage charge pump and shown as a modified example of the charge pump circuit 2. As shown in FIG. 4, the output terminal of the charge pump circuit 3 is connected not to the substrate region but to a circuit (not shown) of a power supply destination, for example. Further, a power supply terminal is used as the reference voltage terminal, and a power supply voltage VDD is supplied as the reference voltage. Furthermore, in the charge pump circuit 3, NMOS transistors are used as the first to fourth drive transistors, and PMOS transistors are used as the rectifier elements. Referring to FIG. 4, an NMOS transistor N11 is illustrated as the first drive transistor, an NMOS transistor N21 is illustrated as the second drive transistor, an NMOS transistor N32 is illustrated as the third drive transistor, an NMOS transistor N42 is illustrated as the fourth drive transistor, a PMOS transistor P33 is illustrated as the first rectifier element, and a PMOS transistor P43 is illustrated as the second rectifier element. The connection between the circuit elements of the charge pump circuit 3 is substantially the same as that of the charge pump circuit 2, so the description thereof is omitted.

Next, the operation of the charge pump circuit 3 will be described. In this exemplary embodiment, the operations of the first charge pump circuit 11 and the third charge pump circuit 13 are described. Note that the description of operations of the second charge pump circuit 12 and the fourth charge pump circuit 14 is herein omitted, because these operations are coupled with the operations of the first charge pump circuit 11 and the third charge pump circuit 13, and these operations are actually the same.

When the high-level first clock signal is supplied to one terminal of a third pumping capacitor C3, the potential of the third pumping node ND3 increases by an amount corresponding to the power supply voltage, after reaching the power supply voltage VDD. Thus, the electric charge is discharged from the third pumping node ND3 to an output terminal OUT through the first rectifier element P33 according to a potential difference between the output terminal OUT and the second pumping node ND4. On the other hand, the first pumping node ND1 is galvanically isolated from the output terminal OUT, because the first drive transistor N11 turns off, as with the operation of the charge pump circuit 1 according to the first exemplary embodiment. Therefore, the potential of the first pumping node ND1 is maintained.

Also in the case of forming a step-up type charge pump circuit as described above, the configuration of the charge pump circuit 3 in which the output terminal is galvanically isolated from the nodes at which the first and second control signals are generated prevents the effect of the output voltage on the voltage level of the first and second control signals. Therefore, also the charge pump circuit 3 can improve the current driving capability and prevents an increase in circuit area, as with the charge pump circuits 1 and 2.

The first to third exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A semiconductor device comprising:
an oscillator which generates complementary first and second clock signals;
a first charge pump circuit which supplies, to a first pumping capacitor, electric charge according to a voltage difference between a voltage level of the first clock signal and a voltage of a reference voltage terminal, through a first drive transistor provided in a first current path, and which generates a first control signal based on the electric charge accumulated in the first pumping capacitor;
a second charge pump circuit which supplies, to a second pumping capacitor, electric charge according to a voltage difference between a voltage level of the second clock signal and a voltage of the reference voltage terminal, through a second drive transistor provided in a second current path, and which generates a second control signal based on the electric charge accumulated in the second pumping capacitor;
a third charge pump circuit which includes a third drive transistor that controls a conductive state of a third current path, and which transfers electric charge between the output terminal and the reference voltage terminal through the third current path; and
a fourth charge pump circuit which includes a fourth drive transistor that controls a conductive state of a fourth current path, and which transfers electric charge between the output terminal and the reference voltage terminal through the fourth current path,
wherein conductive states of the first and third drive transistors are controlled based on the second control signal, and
wherein conductive states of the second and fourth drive transistors are controlled based on the first control signal.

2. The semiconductor device according to claim 1, wherein
the first pumping capacitor has one terminal supplied with the first clock signal, and the other terminal connected to a first pumping node at which the first control signal is generated,
the first drive transistor is connected between the first pumping node and the reference voltage terminal,
the second pumping capacitor has one terminal supplied with the second clock signal, and the other terminal connected to a second pumping node at which the second control signal is generated, and
the second drive transistor is connected between the second pumping node and the reference voltage terminal.

3. The semiconductor device according to claim 1, wherein
the third charge pump circuit includes:
a third pumping capacitor which has one terminal supplied with the first clock signal, and the other terminal connected to a third pumping node, and which accumulates the electric charge; and
a first rectifier element which is connected between the third pumping node and the output terminal, and which allows a current to flow from the output terminal to the third pumping capacitor,
the third drive transistor is connected between the third pumping node and the reference voltage terminal,
the fourth charge pump circuit includes:
a fourth pumping capacitor which has one terminal supplied with the second clock signal, and the other terminal connected to a fourth pumping node, and which accumulates the electric charge; and
a second rectifier element which is connected between the fourth pumping node and the output terminal, and which allows a current to flow from the output terminal to the fourth pumping capacitor, and
the fourth drive transistor is connected between the fourth pumping node and the reference voltage terminal.

4. The semiconductor device according to claim 3, wherein
the first and second rectifier elements are diode-connected transistors, and
terminals corresponding to anode terminals of the transistors are connected to the output terminal.

5. The semiconductor device according to claim 3, wherein
the first rectifier element is a transistor having a polarity opposite to a polarity of the third drive transistor, and having a control terminal supplied with the second control signal, and
the second rectifier element is a transistor having a polarity opposite to a polarity of the fourth drive transistor, and having a control terminal supplied with the first control signal.

6. The semiconductor device according to claim 1, wherein the first to fourth drive transistors are transistors having the same polarity.

7. The semiconductor device according to claim 1, wherein the reference voltage terminal is one of a ground terminal and a power supply terminal.

8. The semiconductor device according to claim 1, wherein the first and second clock signals have an amplitude range from a ground voltage to a power supply voltage.
